(19) United States
(12) Patent Application Publication
(10) Pub. No.: US 2012/0087559 A1
(43) Pub. Date: Apr. 12, 2012

(54) DEVICE AND METHOD FOR CEREBRAL LOCATION ASSISTANCE

(75) Inventors: Pierre Hellier, Thorigne Fouillard (FR); Xavier Morandi, Rennes (FR); Cecilia Naucziciel, Rennes (FR)

(73) Assignee: INRIA INSTITUT NATIONAL DE RECHERCHE EN INFORMATIQ ET EN AUTOMATIQUE, LE CHESNAY (FR)

(21) Appl. No.: 13/145,547

(22) PCT Filed: Jan. 15, 2010
(86) PCT No.: PCT/FR2010/000033

§ 371 Date: Dec. 9, 2011

(30) Foreign Application Priority Data
Jan. 21, 2009 (FR) 09 00254

(51) Int. Cl. G06K 9/00

(52) U.S. Cl. 382/131; 382/128

(57) ABSTRACT

The invention relates to a device and to a method for cerebral location assistance. The device includes first and second memories. The first one is adapted for storing a generic mapping of the brain according to a first space location mode, as well as designation data corresponding to a target area in said mapping. The second one can receive and store, according to a second pace location mode, an operation image of the brain of an analysed subject acquired by medical imaging. The device also includes a non-rigid resetting tool adapted for establishing a conversion of the generic three-dimensional mapping towards the operation image, and a resampling tool for establishing a converted mapping with the converted designation data. A user's interface defines a visualization image that matches the operation image and the converted mapping while indicating an area that corresponds to the converted designation data.

The invention relates to a device and a method for cerebral location assistance.

The invention in particular allows automatic location of the dorsolateral pre-frontal cortex (DLPFC). This location is for example applicable in transcranial magnetic stimulation (TMS), electroencephalography or magnetoencephalography.

Medical imaging techniques are essential today in the medical and scientific fields. Among these techniques, nuclear magnetic resonance imaging (MRI) makes it possible to obtain two- or three-dimensional images (2D or 3D) of a chosen part of the human or animal body. As its name indicates, nuclear magnetic resonance imaging is based on the nuclear magnetic resonance (NMR) technique.

Nuclear magnetic resonance imaging is particularly applicable in neurology because it makes it possible to obtain images of the brain. Furthermore, this technique has allowed the development of new treatment methods such as transcranial magnetic stimulation (TMS).

Transcranial magnetic stimulation (TMS) is a medical technique used in neurology, psychiatry and functional rehabilitation. It allows the treatment of problems in particular including epilepsy, migraines, depression or tinnitus. This technique makes it possible to stimulate a neuroanatomical zone such as the cerebral cortex painlessly and non-invasively. The stimulation is done using a coil transmitting short electromagnetic pulses.

The location of a target neuroanatomical zone is generally done by clinicians on images resulting from medical imaging techniques such as MM images, for example. But this location is difficult to determine precisely and is directly dependent on the clinician's level of expertise (neuroanatomist or neurosurgeon, for example).

During transcranial magnetic stimulation (TMS), a device called a neuronavigator makes it possible to identify, in real-time, the stimulated zone of an analyzed subject (animal or human). To that end, the neuronavigator is generally calibrated on images recorded from a medical imaging device (MRI device in particular). The imaging device therefore provides the necessary images of an analyzed subject's brain. Positioning tools, such as a strip fastened around the analyzed subject's head and in communication with a binocular camera then allow real-time identification of the effectively stimulated zone of the analyzed subject.

Here again, the real-time recognition of the stimulated neuroanatomical zone is difficult and depends directly on the clinician's level of expertise (especially regarding the analysis of the images recorded by the medical imaging device).

Methods to help with the location of a neuroanatomical zone have previously been proposed. Document WO 2004/035135 A1 describes a method for three-dimensional modeling of a skull and internal structures thereof. This method is based on a correlation between the internal structures of a skull and its outer dimensions. Thus, the method aims to deduce the inner structure of a skull from simple dimensional measurements.

Other correlation systems exist in this sense. Indeed, document EP 1 176 558 A2 describes an imaging system allowing a superposition of image elements to obtain an improved image of a target anatomical region. To that end, the system uses dimensional surface measurements and a correlation with volumetric data acquired by X-rays.

Other tools can be associated with a neuronavigator so as to facilitate target zone location. In particular, the Brainsight™ computer tool marketed by the company Rogue Research Inc. targets matching between a brain map called “Talairach atlas” (Talairach & Tournoux, 1988) and MRI image data from an analyzed subject. The matching is done by a geometric analysis implementing coordinate registration.

Nothing satisfactory has been proposed to date to at least partially automate the precise recognition and targeting of a given still-unknown area of a patient's brain.

The present invention aims to improve the situation by proposing another approach.

To that end, the invention relates to a computer device for cerebral location assistance, comprising:
a first memory adapted for storing a general three-dimensional mapping of at least part of the brain according to a first spatial location mode, as well as for storing designation data, established according to the first spatial location mode, and corresponding to a target area of the brain in said mapping;
a second memory adapted to receive and store an operation image of at least part of the brain of an analyzed subject acquired by medical imaging, this operation image being stored according to a second spatial location mode;
a non-rigid registration tool adapted for establishing a registration transformation of the general three-dimensional mapping towards the operation image;
a resampling tool for establishing, according to the registration transformation, a converted mapping, in the format of the second spatial location mode, as well as converted designation data;
a user interface, adapted to form a visualization image, which at least partially matches the operation image and the converted mapping, while indicating, in the visualization image, a zone that corresponds to the converted designation data.

The invention also relates to a method for cerebral location assistance, the method comprising the following steps:
a. charging a general three-dimensional brain mapping;
b. preparing a designation of a brain zone on said general three-dimensional mapping;
c. conducting electromagnetic wave imaging over at least part of the brain of an analyzed subject, to obtain an operation image;
d. applying a non-rigid registration of the general three-dimensional map towards the operation image, to obtain a spatial geometric transformation making it possible to go from the general three-dimensional mapping towards the operation image;
e. from said designation of a brain zone in step b, and from the transformation in step d, determining a target zone in the operation image;
   and
f. presenting an operator with a representation of the target zone of step e, for action on the target zone.

Other advantages and features will appear upon reading the following detailed description and in the appended figures, in which:

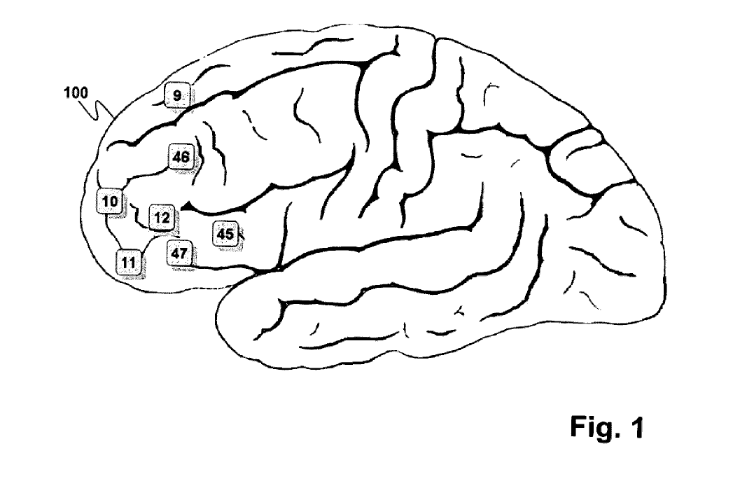

FIG. 1 shows a diagrammatic illustration of a sagittal view of a human brain with indications of Brodmann areas;

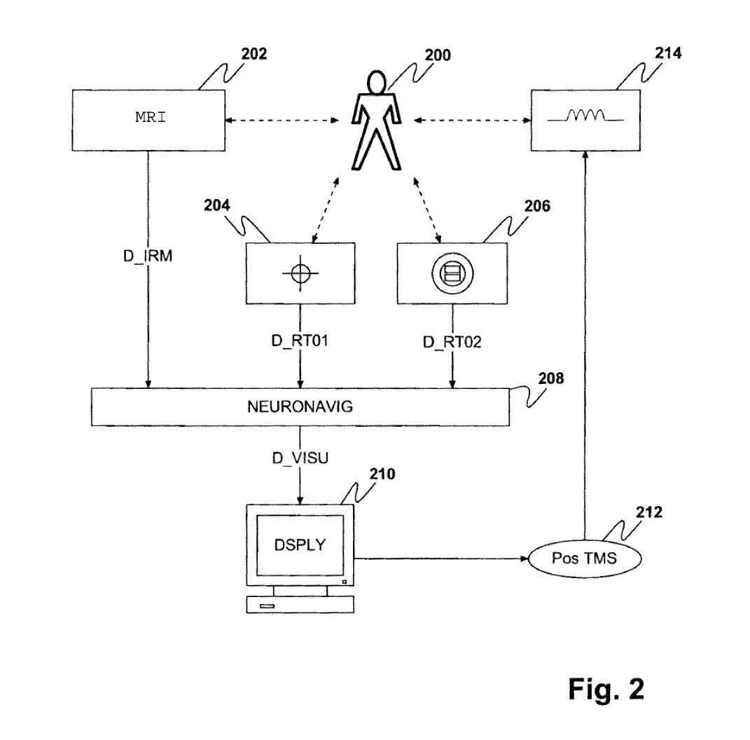

FIG. 2 shows an operating diagram of the transcranial magnetic stimulation (TMS);

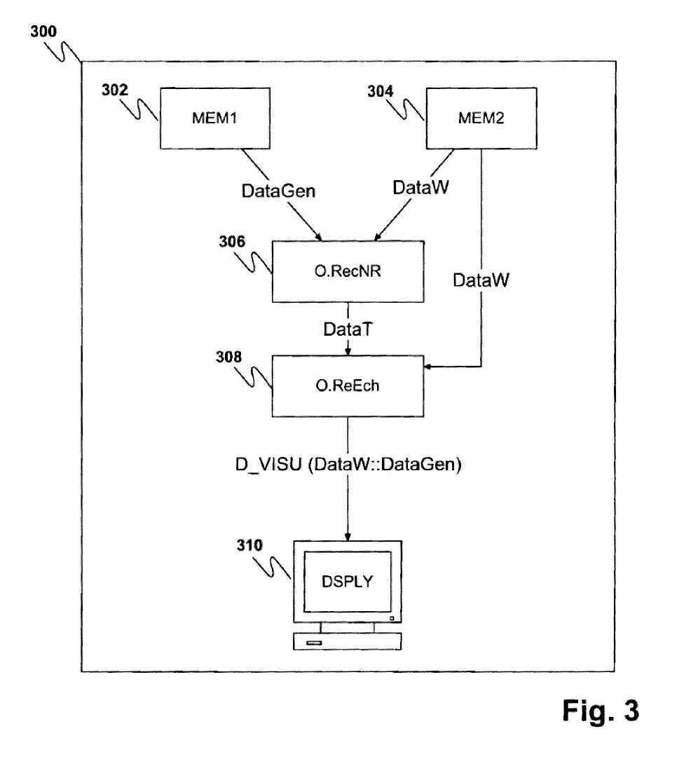

FIG. 3 shows a computer device for brain location assistance according to one embodiment of the invention;

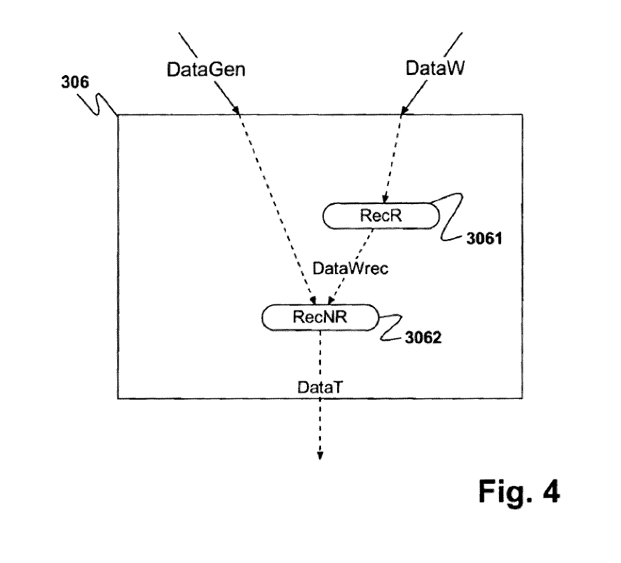

FIG. 4 shows a functional diagram of a non-rigid registration tool according to one embodiment of the invention;

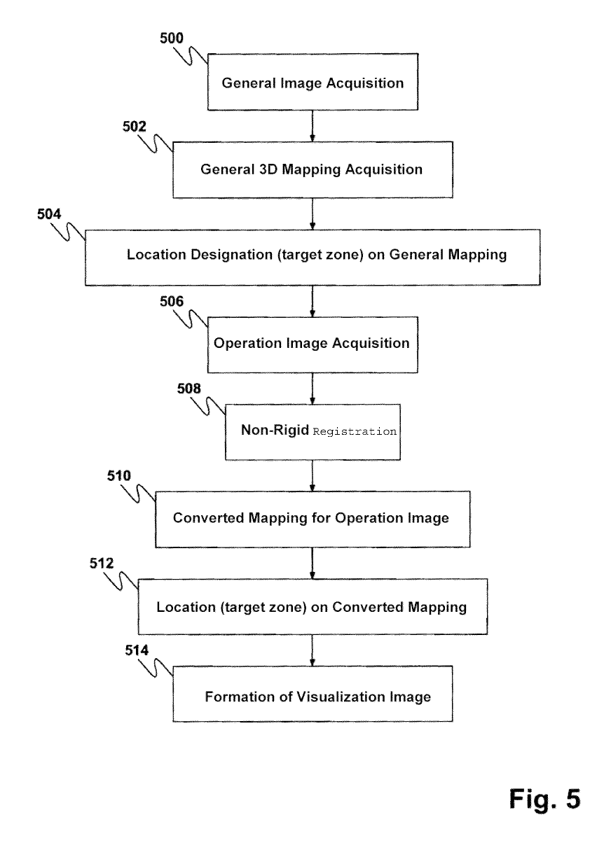

FIG. 5 shows an operational diagram of a method for assisting with brain location according to one embodiment of the invention.

The drawings and description below contain, for the most part, elements of a definite nature. The drawings are an integral part of the description and may therefore not only be used to make the present invention better understood, but also to contribute to its definition if applicable.

The invention will now be described in detail in reference to precise cerebral neuroanatomical zones (in particular the dorsolateral prefrontal cortex). However, the invention is in no way limited to said zones, but rather applies to any cerebral zone accessible by medical imaging (e.g. the orbito-frontal cortex).

More precisely, the invention is described in reference to the dorsolateral prefrontal cortex (DLPFC). Broadly speaking, the dorsolateral prefrontal cortex (DLPFC) corresponds to the interface between areas 9 and 46 of Brodmann's cytoarchitectonic atlas. More precisely, the prefrontal cortex brings together the lateral portions of areas 9-12, part of areas 45 and 46, and the upper part of Brodmann's area 47. The corresponding areas appear on the brain 100 shown in FIG. 1 (Robertson et al, 2001).

The dorsolateral prefrontal cortex is a target zone of the transcranial magnetic stimulation technique (TMS). In fact, one of the main applications of TMS is the treatment of major depressive episodes (depression) through high-frequency repetitive stimulations of the left dorsolateral prefrontal cortex (Gershon & al, 2003, Loo &Mitchell, 2005; Gross & al, 2007). To that end, the latter must be located beforehand by a specialized clinician. The precision of this location is crucial to take full advantage of the TMS.

However, this location is manual, lengthy, difficult and dependent on the level of expertise of the practicing clinician. Generally, a standardized method initially proposed by George & al, then by Pascual-Leone & al, is applied. This method is based on Talairach's atlas (Talairach & Tournoux, 1988) and it has been shown that it is imprecise and does not sufficiently account for the anatomical variability existing between different individuals. This can consequently result in imprecise magnetic stimulations (Herwig & al, 2001).

Very briefly, this standardized method consists of applying the following 4 steps:
1. determining the left central groove from a “hook” structure visible in sagittal cross-section and an “omega”-shaped structure visible in axial cross-section;
2. determining the left pre-central groove situated at the front of the left central groove visible in the sagittal cross-section and the axial cross-section;
3. determining the upper and middle frontal gyri on the axial and sagittal cross-sections, by determining the upper frontal groove separating them.
4. adjusting, in coronal cross-section, the location of the middle frontal gyms relative to the location of the upper frontal groove determined in the preceding step.

As a general rule, any clinician using a neuronavigator during a TMS must therefore use, in real time, the standardized method described above so as to correctly stimulate the target zone. The required positioning is very fine, and the “field,” i.e. the brain to be examined, is not available in the form of a sufficiently precise computer description. This is why, until now, the positioning is essentially defined by the operating clinician.

The present invention greatly improves the state of the art and uses a non-rigid registration tool allowing a registration transformation between distinct images acquired by medical imaging (MRI in particular). This allows the computer device according to the invention an automation of the location of a target zone of the brain.

FIG. 2 shows an operating diagram of the transcranial magnetic stimulation technique (TMS).

An analyzed subject 200, for example an individual suffering from migraines or depression, is subjected to a magnetic field by an MM apparatus 202 so as to obtain three-dimensional image data D_IRM of the brain. The image data D_IRM coming from the MRI apparatus 202 is sent to a neuronavigator 208.

In order to conduct the electromagnetic stimulations in real-time, the analyzed subject is in direct interaction with a positioning system made up, on the one hand, of a positioning tool 204 such as a strip fastened around the analyzed subject's head, and on the other hand, of a camera 206 in direct or indirect relation with the positioning tool. The camera can in particular be a binocular camera. The interactions between the analyzed subject 200, positioning tool 204 and camera 206 form real-time data D-RT that is sent to the neuronavigator 208. In the described embodiment, the real-time data D_RT is made up of data D_RT01 coming from the positioning tool 204 and data D_RT02 coming from the camera 206. The set of real-time data D_RT and image data D_IRM forms operation data DataW as detailed later.

The neuronavigator 208 connects the MRI image data D_IRM and the real-time data D_RT. The neuronavigator 208 then sends visualization image data D_VISU to a user interface 210. The interface 210 then shows a visualization image. An operator can use the visualization image to proceed with the positioning 212 of a coil 214 for the emission of electromagnetic pulses.

The real-time data D_RT coming from interactions between the analyzed subject 200, positioning tool 204 and camera 206 makes it possible for the operator to adjust the positioning 212 of the coil 214 for each emitted electromagnetic pulse. The adjustment precision is directly dependent on the operation of the neuronavigator as well as its implementations.

During the transcranial magnetic stimulation (TMS) technique and more precisely during neuronavigation with a neuronavigator 208, the computer device for cerebral location assistance makes it possible to monitor, precisely and in real time, the zone actually stimulated by the magnetic stimulations of the TMS. To that end, as described above, the position of the TMS instruments, in particular the coil 214, the positioning tool 204 and the camera 206, is adjusted relative to the visualization image presented on the user interface 210.

First, the device of the invention performs a rigid registration of the space of the MRI images of the analyzed subject with the space of the real-time data, via a geometric transformation. This registration is therefore done within the operation data DataW, and more precisely between the image data D-IRM and the real-time data D_RT. “Image space” or “real-time data space” refer to a system of coordinates and a spatial location. This type of rigid alignment can in some cases be considered sufficient for the location of deep structures (e.g. central grey cores), but lacks precision for cortical structures having a high interindividual anatomical variability (Hellier & al, 2003).

However, to allow registration between distinct images, the registration tool ensures not only the rigid registration described above, but also non-rigid registration. The Applicant has surprisingly discovered that a non-rigid registration as described below allows a precise, reproducible and automatable location of a target zone of a brain.

The registration tool comprised in the device of the invention is arranged to use a non-rigid registration transformation. This non-rigid registration transformation was previously set up by the Applicant. It is called “ROMEO” (Robust Multilevel Elastic Registration Based on Optical Flow) and is described in detail in the scientific publication “Hierarchical Estimation of a Dense Deformation Field for 3-D Robust Registration” in IEEE Trans. Med. Imag., vol. 20, pp. 388-402, no. 5, May 2001 (Hellier & al, 2001) and to which the reader is invited to refer.

The non-rigid registration transformation applied in the invention in particular allows independence between the spatial location spaces (systems of coordinates) of the different manipulated images (general three-dimensional mapping, operation image or visualization image). The location spaces can in particular be systems of Cartesian coordinates (used in a vectorial space or an affine space), curvilinear coordinate systems, cylindrical coordinate systems, spherical coordinate systems, or others.

In short, the registration transformation of the invention estimates a dense field of geometric deformation between three-dimensional images. The transformation is based on the hypothesis of invariance of the luminescence during the movement of a physical point (robust statistical framework)—the so-called optical flow hypothesis (Horn & al, 2003). It is based on a multi-modality non-rigid registration algorithm using similarity measurements (the measurements of similarities being done in the context of a multi-grid minimization). Regularizations (not detailed here) are introduced so as to favor the estimation of the spatially coherent field. To reduce the sensitivity of the method to noise, and to allow the introduction of spatial discontinuities on the deformation field, robust estimators are introduced. This therefore involves a transformation based on a hierarchical, multi-resolution and multi-grid approach.

It is specified that the multi-resolution comprises: the hierarchical estimation of deformation fields on images derived from initial images by filtering and sub-sampling. Multi-grid refers to the estimation of deformations over a series of overlapping spaces, i.e. starting from the coarsest resolution level towards the finest resolution level. Each space is defined by an affine parameterization by pieces based on a spatial partition of the volume. The multi-grid spaces are therefore overlapping, inasmuch as the spatial partitions fit together (i.e. the transition to a finer grid level corresponds to an adaptive subdivision of the spatial partition).

In other words, each grid level has a corresponding partition, and when one goes to the finest grid level, the spatial partition is adaptively cut out. This is illustrated in the scientific publication “Hierarchical estimation of a dense deformation field for 3D robust registration” (Hellier & al, 2001), in particular FIGS. 2 (a) and (b), and their description.

FIG. 3 relates to the invention and shows a computer device for cerebral location assistance 300 according to one embodiment of the invention. The device 300 comprises a first memory 302 capable of storing data such as, for example, a RAM-type memory (Random Access Memory). This first memory 302 is arranged to store a general three-dimensional mapping of at least part of a brain. In the described embodiment, this general three-dimensional mapping is established by a neuroanatomy expert on a brain image recorded by magnetic resonance imaging (MRI). The brain to which reference is made at this stage is a brain that can be qualified as a model brain or general brain. The general three-dimensional mapping is stored in the first memory 302 according to a first spatial location mode (or system of coordinates). The general three-dimensional mapping comprises the location of zones of interest such as, for example, the dorsolateral prefrontal cortex (DLPFC) or the orbito-frontal cortex. The first memory 302 can therefore also store precise designation data. This designation data corresponds to a target zone of the brain and is generally stored according to the first spatial location mode as the general three-dimensional mapping. The target zone of the brain can in particular be chosen according to the targeted treatment. For example, for the curing of depressions, the target zone will be the dorsolateral prefrontal cortex (DLPFC).

In the mode described here, the computer device for cerebral location assistance 300 comprises a second memory 304 capable of storing data (RAM type). The second memory 304 is arranged to receive and store an operation image for at least part of the brain of an analyzed subject (such as, for example, a depression suffering patient). The operation image is acquired by medical imaging such as magnetic resonance imaging (MRI), like the general three-dimensional mapping, but according to a second precise space location mode that is generally not identical to that of the mapping (because it can involve a distinct MRI apparatus or different acquisition sequence modes). However, the two spatial location modes are not necessarily distinct. In the embodiment described here, the operation image is stored according to a second spatial location mode.

The computer device 300 comprises a non-rigid registration tool 306 that receives general three-dimensional mapping data DataGen and operation data DataW of the first memory 302 and the second memory 304, respectively. It is from this data (DataGen and DataW) that the non-rigid registration tool 306 establishes a registration transformation from the general three-dimensional mapping towards the operation image.

The image data (operation image) coming directly from the analyzed subject can then be resampled in the coordinate system of the general three-dimensional mapping.

FIG. 4 shows an operating diagram of the non-rigid registration tool 306. In one embodiment, a rigid registration operation 3061 acts on the operation data DataW by performing a rigid registration as described above, i.e. a rigid registration between the image data D_IRM and the real-time data D_RT. The rigid registration operation provides registration operation data DataWrec, corresponding to the transformation of the MRI image data D_IRM towards the real-time data D_RT (or vice versa). According to one embodiment, the rigid registration of the operation 3061 uses a statistical method called “mutual information maximization” (Maes & al, 1997).

A non-rigid registration operation 3062 then performs a non-rigid registration of the general three-dimensional mapping data DataGen towards the registration operation data DataWrec (or vice versa). To that end, the non-rigid registration operation 3062 uses the ROMEO non-rigid registration transformation described above.

The registration tool 306 therefore implements a computer program for establishing a non-rigid registration transformation using the ROMEO method. The non-rigid registration tool 306 provides transformation data DataT substantially representing the registration transformation of the general three-dimensional mapping towards the operation image.

In the embodiment described here of the device of the invention, the application of the registration transformation is done by a resampling tool 308 shown in FIG. 3. The resampling tool 308 establishes, according to the registration transformation DataT, a converted mapping, in the format of the second spatial location mode of the operation image. In other words, the registration transformation DataT established by the registration tool 306 is applied to the operation data DataW (corresponding to the operation image) to provide a converted mapping according to the second spatial location mode.

The resampling tool 308 provides, as output, visualization data D_VISU allowing “matching” of the general three-dimensional cartography with the operation image (DataW::DataGen). This “matching” substantially corresponds to said converted mapping. Consequently, the resampling tool 308 establishes the converted designation data making it possible to find a target zone (detailed below). The converted designation data then substantially corresponds to the designation data of the target zone of the brain determined beforehand on the general three-dimensional mapping.

The computer device 300 also comprises a user interface 310, arranged to form a visualization image. This visualization image is formed from visualization data D_VISU and at least partially matches the operation image and the converted mapping, while indicating, in the visualization image, a zone that corresponds to the converted designation data.

FIG. 5 shows an operational diagram of a method for cerebral location assistance according to one embodiment of the invention. A first general image acquisition operation 500 makes it possible to obtain a general image of a brain. This operation generally consists of conducting electromagnetic wave imaging on the brain of a reference subject, for example by MRI. The general image of the brain thus obtained is used during a general mapping acquisition operation 502 to establish a general three-dimensional mapping, from said general brain image. These two operations (500 and 502), once done, can be unique for any embodiment of the method of the invention. In fact, once the general mapping is established, it can be used for any embodiment of the method of the invention. The following target zone designation operation on the general mapping 504 consists of preparing a designation of a brain zone on said general three-dimensional mapping. Then an operation image acquisition operation 506 consists of conducting electromagnetic wave imaging over at least part of an analyzed subject's brain. This operation 506 makes it possible to obtain an operation image. A non-rigid registration operation 508 applies a non-rigid registration of the general three-dimensional mapping towards the operation image, to obtain a spatial geometric transformation making it possible to go from the general three-dimensional mapping towards said operation image acquired during the operation image acquisition operation 506. A conversion operation 510 then establishes a converted mapping for the operation image. Then, from the target zone designation operation on the general mapping 504 and the non-rigid registration operation 508, a target zone location operation 512 determines the target zone in the operation image (in particular owing to the conversion operation 510). Lastly, a visualization image formation operation 514 consists of presenting an operator with a representation of the target zone, for action on said targeted zone. The action can in particular be a transcranial magnetic stimulation.

### EXAMPLE

25 analyzed subjects were subjected to magnetic resonance imaging (MRI).

To obtain results relative to the state of the art, on the one hand three clinicians proceeded with the dorsolateral prefrontal cortex (DLPFC) location using a manual method and on the other hand a cerebral location method by rigid registration was applied (Maes & al, 1997).

To obtain results relative to the invention, a method for cerebral location assistance was applied with the device of the invention (non-rigid registration).

Table 1 shows the comparative analysis between the invention and the state of the art.

TABLE 1
Comparative analysis between the invention and the state of the art

| SUBJECT | Clinician 1 | Clinician 2 | Clinician 3 | Rigid | Non-rigid |
|---|---|---|---|---|---|
| 1 | 1.78 | 6.29 | 10.56 | 8.53 | 4.42 |
| 2 | 2.70 | 11.99 | 2.70 | 6.66 | 7.38 |
| 3 | 1.16 | 17.68 | 26.72 | 10.45 | 11.91 |
| 4 | 7.91 | 2.23 | 15.34 | 20.20 | 10.74 |
| 5 | 6.75 | 8.82 | 11.03 | 10.16 | 3.47 |
| 6 | 5.65 | 17.05 | 10.12 | 6.62 | 8.01 |
| 7 | 11.55 | 24.44 | 18.40 | 15.80 | 7.30 |
| 8 | 10.07 | 9.21 | 12.84 | 13.62 | 6.61 |
| 9 | 7.42 | 6.05 | 4.30 | 23.13 | 8.88 |
| 10 | 4.48 | 11.63 | 21.27 | 10.92 | 9.34 |
| 11 | 8.80 | 7.85 | 20.98 | 8.58 | 8.21 |
| 12 | 3.36 | 5.50 | 18.24 | 5.49 | 4.20 |
| 13 | 12.10 | 5.16 | 12.11 | 7.87 | 5.27 |
| 14 | 6.66 | 4.27 | 6.27 | 8.08 | 4.75 |
| 15 | 5.19 | 17.11 | 5.97 | 14.25 | 13.98 |
| 16 | 6.82 | 9.56 | 9.58 | 7.57 | 5.63 |
| 17 | 5.71 | 9.82 | 14.13 | 4.12 | 5.52 |
| 18 | 4.75 | 14.21 | 17.38 | 3.87 | 4.72 |
| 19 | 10.72 | 17.58 | 14.38 | 7.44 | 8.68 |
| 20 | 8.85 | 14.02 | 21.58 | 2.67 | 6.28 |
| 21 | 4.97 | 4.60 | 19.73 | 7.27 | 1.33 |
| 22 | 3.29 | 5.69 | 22.18 | 12.48 | 10.83 |
| 23 | 12.96 | 17.23 | 2.98 | 16.75 | 16.09 |
| 24 | 8.57 | 23.70 | 20.17 | 2.95 | 7.70 |
| 25 | 14.41 | 13.47 | 17.40 | 6.51 | 7.65 |
| Average | 7.07 | 11.41 | 14.26 | 9.68 | 7.56 |
| Standard | 3.53 | 6.09 | 6.61 | 5.22 | 3.35 |
| deviation | | | | | |

The results of the table show the inter-variability between the results of the manual location of the dorsolateral prefrontal cortex (DLPFC) done by clinicians (columns: clinician 1, clinician 2 and clinician 3). The automatic location of the invention is more precise and reproducible.

Furthermore, the method for cerebral location assistance with non-rigid registration (column: non-rigid) provides better results relative to the rigid registration method (column: rigid) of the prior art. This is in particular due to the larger number of degrees of freedom of the non-rigid registration, which allows better adaptation in light of the anatomical variability existing between different analyzed subjects. In fact, it is noted that a rigid registration as known in the state of the art includes 6 degrees of freedom. The non-rigid registration relative to the invention has about 40 million degrees of freedom.

In practice, the precision of a neuronavigation system is about 2 mm. To take full advantage of this system, it is important for the target zone to be defined precisely on the MRI. It will be noted that the clinicians could commit errors going beyond 10 mm in the location of this target zone, which considerably damages the precision of TMS stimulations. The average clinician error is about 1 cm, which is not favorable to optimal use of a neuronavigator.

The invention in particular allows clinicians to do without manual location. The location assistance method and the device of the invention are more precise than manual location by a clinician can be. Additionally, the invention is reproducible.

To achieve this, it was necessary to ensure the anatomical coherence of the deformations observed when going from one subject to the next. To guarantee this coherence at a sufficient level, the estimated deformation field should be regularized. The adjustment of this regularization is particularly difficult in the absence of “field truth” (the “true” deformation field is not known between the brains of two different subjects). It is therefore impossible to have access to absolute criteria to validate the registration techniques. That is why the precision and reproducibility obtained here are significant.

### REFERENCES/PUBLICATIONS

Gershon A, Dannon P N, Grunhaus L; Transcranial Magnetic Stimulation in the treatment of depression; 2003; Am J Psychiatry 160: 835-845
Gross M, Nakamura L, Pascual-Leone A, Fregni F; Has repetitive transcranial magnetic stimulation treatment for depression improved? A systematic review and meta-analysis comparing the recent vs the earlier rTMS studies; 2007; Acta Psychiatria Scand 116: 165-173
Hellier P, Barillot C, Memin E, Perez P; Hierarchical estimation of a dense deformation field for 3D robust registration; 2001; IEEE Transactions on Medical Imaging 20: 388-402
Hellier P, Barillot C, Corouge I, Gibaud B, Le Goualher G, Collins D L, Evans A, Malandain G, Ayache N, Christensen G E, Johnson H J; Retrospective evaluation of inter-subject brain registration; 2003; IEEE Transactions on Medical Imaging, 22(9): 1120-1130
Herwig U, Padberg F, Unger J, Spitzer M, Schönfeldt-Lecuona C; Transcranial Magnetic Stimulation Studies Examination of the Reliability of “Standard” Coil Positioning by Neuronavigation; 2001; Biol Psychiatry 50:58-6
Horn B, Shunck B; Determining optical flow; 1981; Artificial Intelligence 17: 185-2003
Loo C K, Mitchell P B; A review of the efficacy of transcranial magnetic stimulation treatment for depression, current and future strategies to optimize efficacy; 2005; J of Affective Disorders 88: 255-267
Maes F, Collignon A, Vandemeulen D, Marchal G, Suetens P; Multimodality image registration by maximization of mutual information; 1997; TMI 16: 187-198
Robertson E M, Tormos J M, Maeda F, Pascual-Leone A; The Role of the Dorsolateral Prefrontal Cortex during Sequence Learning is Specific for Spatial Information, Cerebral Cortex; 2001; 11(7): pp. 628-635
Talairach J, Tournoux P; Echo-planar stereotaxis atlas of human brain; 1988; New York: Thieme Medical Publishers
Yousry T A Schmid U D, Alkadhi H, Schmidt D, Peraud A, Buettner A, Winkler P; Localization of the motor hand area to a knob on the precentral gyms. A new landmark; 1997; Brain; January; 120 Pt 1): 141-57

1. A computer device for cerebral location assistance, comprising:
a. a first memory device adapted for storing a general mapping of at least part of the brain according to a first spatial location mode, as well as designation data, established according to the first spatial location mode, and corresponding to a target zone area of the brain in said mapping;
b. a second memory device adapted to receive and store an operation image of at least part of the brain of an analyzed subject acquired by medical imaging, this operation image being stored according to a second spatial location mode;
c. a non-rigid registration tool adapted for establishing a registration transformation of a general three-dimensional mapping towards the operation image;
d. a resampling tool for establishing, according to the registration transformation, a converted mapping, in the format of the second spatial location mode, as well as converted designation data; and
e. a user interface, adapted to form a visualization image, which at least partially matches the operation image and the converted mapping, while indicating, in the visualization image, a zone that corresponds to the converted designation data.

2. The device according to claim 1, wherein the registration transformation by the non-rigid registration tool comprises comprising a rigid registration transformation and a non-rigid registration transformation.

3. The device according to claim 1, wherein the target zone is the dorsolateral prefrontal cortex (DLPFC).

4. The device according to claim 1, wherein the target zone is the orbito-frontal cortex.

5. The device according to claim 1, wherein the medical imaging for acquiring the operation image is magnetic resonance imaging (MRI).

6. The device according to claim 1, also comprising a neuronavigator in which the first and second memory devices, the non-rigid registration tool, the resampling tool and the user interface are arranged, said neuronavigator serving to assist a brain operation.

7. The device according to claim 1, also comprising a positioning system and a coil for transcranial magnetic stimulation.

8. A method for cerebral location assistance, the method comprising the following steps:
a. charging a general three-dimensional brain mapping;
b. preparing a designation of a brain zone on said general three-dimensional mapping;
c. conducting electromagnetic wave imaging over at least part of the brain of an analyzed subject, to obtain an operation image;
d. applying a non-rigid registration of the general three-dimensional map towards the operation image, to obtain a spatial geometric transformation making it possible to go from the general three-dimensional mapping towards the operation image;
e. determining a target zone in the operation image from said designation of a brain zone in step b, and from the transformation in step d; and
f. presenting an operator with a representation of the target zone of step e, for action on the target zone.

9. The method according to claim 8, wherein step a. for charging a general three-dimensional mapping comprises the following steps:
a1. conducting electromagnetic wave imaging on a reference subject's brain, to obtain a general brain image;
a2. establishing a general three-dimensional mapping, from said general brain image (502).

10. The method according to claim 8, wherein the action on the target zone in step f is a transcranial magnetic stimulation.

11. The method according to claim 8, further comprising a step:
d1. for establishing a converted mapping from the spatial geometric transformation obtained in step d.

12. The method according to claim 8, wherein the target zone is the dorsolateral prefrontal cortex.

13. The method according to claim 8, wherein the target zone is the orbito-frontal cortex.
